(19) United States
(12) Patent Application Publication
(10) Pub. No.: US 2025/0100628 A1
(43) Pub. Date: Mar. 27, 2025

(54) IMPACT RESISTANT LIGHTWEIGHT COMPOSITE STRUCTURES AND USES THEREOF

(71) Applicants: Tiercon Corp., Stoney Creek (CA); Ruiz Aerospace Manufacturing Inc., Laval (CA)

(72) Inventors: Chris Campbell, Ontario (CA); Jeff Charboneau, ontario (CA); Joshua Slee, Ontario (CA); Eduarddo Ruiz, Québec (CA)

(73) Assignees: Tiercon Corp., Stoney Creek, ON (CA); Ruiz Aerospace Manufacturing Inc., Laval (CA)

(21) Appl. No.: 18/728,845

(22) PCT Filed: Jan. 12, 2023
(86) PCT No.: PCT/CA2023/050033

§ 371 Date: Jul. 12, 2024

Related U.S. Application Data
(60) Provisional application No. 63/299,744, filed on Jan. 14, 2022.

(51) Int. Cl. B62D 25/20; B32B 5/02; B32B 5/12; B32B 7/022; B32B 7/12; B62D 29/04

(52) U.S. Cl. CPC B62D 25/2072; B32B 5/024; B32B 5/12; B32B 7/022; B32B 7/12; B62D 29/043; B32B 2250/20; B32B 2262/101; B32B 2262/106; B32B 2307/546; B32B 2307/558; B32B 2571/00; B32B 2605/00

(57) ABSTRACT

There is provided a composite load protection structure for protecting body-side impact-sensitive components of a vehicle from a strike by a load, the structure comprising: a core fabric layer; an impact-facing layer on one side of the core fabric layer and a body-facing stabilizing layer on the other side of the core fabric layer; and an adhesive to bond the impact-facing layer and the body-facing stabilizing layer on the opposed sides of the core fibre layer, wherein the core fabric layer has a lower stiffness and increased ductility than the impact-facing layer and the body-facing stabilizing layer.

### CROSS REFERENCE TO RELATED APPLICATIONS

This application claims priority to U.S. provisional application No. 63/299,744 filed Jan. 14, 2022, which is hereby incorporated by reference in its entirety.

### TECHNICAL FIELD

The present invention relates to impact resistant lightweight composite structures and uses thereof.

### BACKGROUND

Skid plates are used underneath vehicles for the protection of the engine, transmission, and other impact-sensitive components such as batteries. Widely commercially available skid plates are commonly made using two types of materials: steel or aluminum. Steel skid plates range between 1 and 3 mm thick plates and in varying material strengths. Aluminum plates are generally fabricated out of 2-6.35 mm thick plates. While these materials are well known to be stiff and resistant to impacts, they are however, heavy and add to the overall weight of the vehicles and increased overall weight is less desirous from an efficiency standpoint. As well, currently used materials such as metal are prone to corrosion over time. Moreover, the inherent mass of metal plates is also a challenge for the operators in plants as they are typically installed to the vehicle underbody from a position over the head of the operator beneath. In addition to complications owing to the increased mass and difficult installation orientation is the general size of the plate and multiple attachment locations. These drawbacks encountered during initial vehicle production also are reencountered during maintenance of heavy vehicles and light trucks because the disassembly and repositioning of metallic skid plates may be challenging due to their weight and size.

Some high-performance vehicles such as luxury cars and two and three-wheeled vehicles have migrated from metallic skid plates to some composite materials. Exemplary composites are commonly monolithic laminates of carbon fibers and/or glass fibres (e.g. glass pp composites). These laminates are monolithic laminates (i.e. laminate of plies of the same fabric at different orientations). Monolithic laminates of carbon fibers are expensive and while they may be stiff, stiff material can be more prone to cracking or scratching under impact load. Therefore, while some commercially available skid plates are very light and some are stiff, they act merely as guards and are limited in long term performance due to progressive surface degradation from impacts and scratches. Consequently, monolithic laminates need replacement more often than their metallic counterparts.

In the light truck industry, skid plates are more challenging as they not only need to protect the engine from impacts but also need to be stiff enough to hold the weight of the vehicle when lifted such as when the light truck is driven over an obstacle. Metallic skid plates engineered for light truck usage can weigh up to 24 kg, which can make their assembly and disassembly even more challenging and as well as adding to the overall weight of the light truck. Such additional mass is contrary to the aim for decreasing weight to aid in improving fuel economy.

As well, there is need is ever more present during the push for electrification of light trucks and/or electrification of vehicles, in general, to lighten the overall vehicle and increase efficiency and/or driving characteristics. In the case of electrified light trucks and/or electrified vehicles, these will include a plurality of batteries. These batteries are heavy and in order to minimize effects on the center-of-mass of the truck or vehicle, the batteries typically mounted as close to ground as possible. However, if the housing supporting the batteries is not adapted to receive impacts then this can expose the batteries to undesirable forces from the impact that can leading to damage to the batteries and undesired electric shock and/or fires.

Vehicles include protective measures designed to protect the vehicle from minor collisions and dents/scrapes. Among these include bumpers designed to deform to absorb the energy of the impact to prevent damage to sensitive areas of the body panels and/or chassis. These bumpers are typically cheaper to mend or replace than body panels and/or chassis. Bumpers used for some light trucks are made from steel and aluminum and contribute to overall weight. Therefore, there is a need to develop bumpers using collision energy absorbing materials which are lightweight and have sufficient strength and/or stiffness to protect from impact by being able to withstand minor impacts and/or then absorb the energy of the impact.

Therefore, there is a need for material that can keep similar mechanical performance of steel and aluminum and avoiding corrosion and having fire resistance all the while being lightweight, sufficiently stiff, is also less prone to cracking or scratching under impact load, and can deflect or release the impact energy across a wider section of the material to protect engine, transmission, and other impact-sensitive components such as batteries, or the body of the vehicle.

### SUMMARY OF THE INVENTION

In one aspect, the present inventions relates to vehicle protection apparatus having similar mechanical performance to steel and aluminum, but with corrosion avoidance and reduced weight.

In one aspect, the present invention relates to composite structures for use in manufacturing skid plates having reduced mass, improved or similar impact resistance, improved or equivalent stiffness, with commercially competitive costs.

In one aspect, the present invention relates to lightweight composite structures that have superior stiffness, superior impact resistance, and decreased weight for the formation of skid plates for vehicles comprising a composite material comprising layers of fabric configured to have a controlled deformation.

In one aspect, the present invention relates to lightweight composite structures that minimize fabric shear deformation to improve mechanical performance, drapability, and manufacturability.

In one aspect, the present invention relates to a hybrid composite material, methods of manufacturing thereof, and uses thereof that has optimized mechanical performance suitable for use as a skid plate.

It is an embodiment of the present invention to provide a composite structure for use as load protection apparatus to protect body-side impact-sensitive components from a strike by a load, the structure comprising:
a core fabric layer;
a impact-facing layer on one side of the core fabric layer and a body-facing stabilizing layer on the other side of the core fabric layer; and
an adhesive to bond the impact-facing layer and the body-facing stabilizing layer on opposed sides of the core fibre layer, wherein the core fabric layer has a lower stiffness and increased ductility than the surrounding load-facing layer and the body-facing stabilizing layer.

In aspects, the impact-facing layer comprises an outward-facing spread carbon fibre chop layer configured to receive the strike; and a load-facing stiffening carbon fibre layer.

In one aspect, the present invention relates to a composite comprising one or more stiffening layers and one or more fibre layers will direct the amount of deflection caused by the strike from the load.

In aspects, the one or more stiffening layers comprise carbon fibre and/or the one or more fibre layers are glass fibre layers.

It is an embodiment of the present invention to provide a composite structure for use as an skid plate to protect body-side impact-sensitive components from a strike by a load, the structure comprising:
a core glass fabric layer configured to increase moment of inertia and receive deformation upon the strike by the load;
a ground-facing stiffening layer on one side of the core glass fabric layer and a body-facing stabilizing layer on the other side of the core glass fabric layer, the ground-facing stiffening layer comprising carbon fibre; and
a resin to bond the ground-facing stiffening layer and the body-facing stiffening layer to core glass fibre layer.

In aspects, the structure further comprises a spread carbon fibre chop layer bonded to the ground-facing stiffening layer and configured to receive the strike by the load.

In aspects, the core glass fabric layer comprises one or more plies of glass fibres. In aspects, the core glass fabric is cross-plied such that the fiber alignment direction of one layer is rotated at an angle with respect to the fiber alignment direction of another layer. In some aspects, the core glass fabric layer comprises three plies. In one aspect, the three plies of glass fibres are aligned in such a manners that a second ply is rotated at 90 degrees with respect to a first ply and a third ply applied over the second ply but this third ply is rotated at 45 degrees with respect to the first layer.

In aspects, the ground-facing stiffening layer or both the ground-facing stiffening layer and the body-facing stiffening layer comprise 12 k carbon fibre.

In aspects, the ground-facing stiffening layer or both the ground-facing stiffening layer and the body-facing stabilizing layer comprise a plurality of plies of carbon fibres. In aspects, the plurality of plies carbon fibre are cross-plied such that the fiber alignment direction of one layer is rotated at an angle with respect to the fiber alignment direction of another layer.

In aspects, the layers of the composite structure are bonded together using a resin, and in further aspects, the resin is an epoxy resin.

### BRIEF DESCRIPTION OF THE DRAWINGS

FIG. 1 is a bottom view of lightweight composite secured to a truck in accordance with an embodiment of the invention;

FIG. 2 is a bottom view showing the impact-facing surface of lightweight composite in accordance with an embodiment of the invention;

FIG. 3 is a cross-sectional view of the lightweight composite along the line A-A in FIG. 2;

FIG. 4 is a close up view of the circled area B in FIG. 3;

FIG. 5 is an exploded view showing the various layers in isolation from the lightweight composite as depicted in FIGS. 2 to 4; and

FIG. 6 is a front end view of the lightweight composite as depicted in FIGS. 2 to 5;

FIG. 7 is a photo of the outward-facing spread carbon fibre chop material for use in forming a layer of the composite according to an embodiment of the invention.

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

In one aspect, the invention provides lightweight composite structures that have superior stiffness, impact resistance, corrosion and fire resistance, and decreased weight for the formation of underbody protection articles for vehicles.

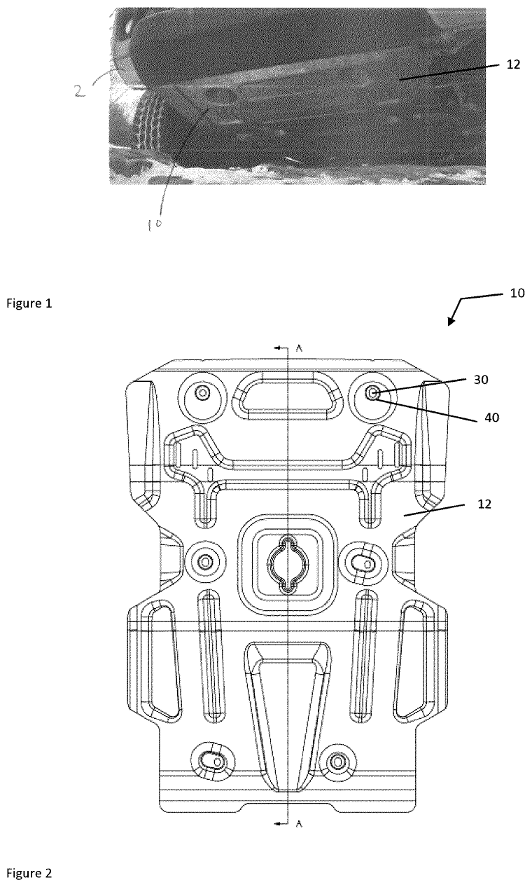

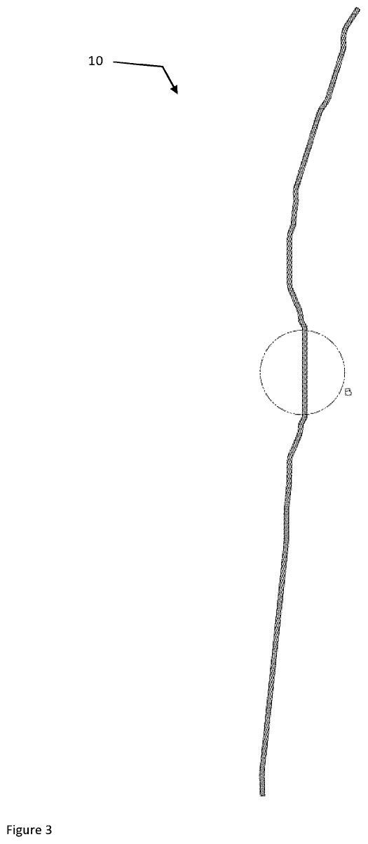

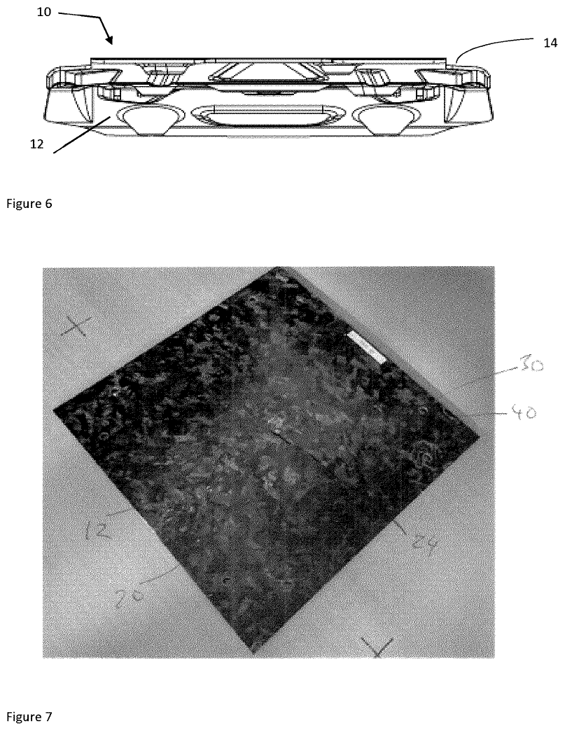

As illustrated in FIG. 1, a composite structure 10 for use as a skid plate is secured to the underbody of a vehicle 2 to protect impact-sensitive components of the vehicle 2. As will be illustrated in more detail below and in the embodiment shown in FIGS. 2 to 6, the composite structure 10 includes an impact-facing surface 12, a body-facing surface 14 opposed to the impact-facing surface 12, and a core 16 between the impact-facing surface 12 and the body-facing surface 14. In one aspect, the composite structure 10 is configured to have sufficient impact resistance to prevent penetration by a load striking the impact-facing surface 12.

As shown in FIGS. 1 to 7, the impact-facing surface 12 is formed using high stress materials comprising carbon fibre. In one aspect, the impact-facing surface 12 comprises one or more carbon fibre layers. In the embodiment shown in FIGS. 1 and 2, the impact-facing surface 12 comprises two carbon fibre layers: an outward-facing spread carbon fibre chop layer 20; and a load-facing stiffening carbon fibre layer 22.

With reference to FIG. 7, the spread carbon fibre chop layer 20 is arranged to initially encounter the load strike and if the forces are not especially significant to deform or damage the spread carbon fibre chop layer 20, this spread carbon fibre chop layer 20 will provide sufficient protection from the load strike. The use of spread carbon fibre chop layer 20 for the impact-facing surface may have additional advantages by serving to conceal one or more small scuffs 24 caused by one or more historical strikes.

The load-facing stiffening layer 22 is configured to provide significant stiffening properties. In one aspect, the load-facing stiffening layer 22 comprises one or more layers of carbon fibre, preferably 12 k carbon fibre. While 12 k carbon fibre is used in the present embodiment, other known types such as 3k, 6k, and 15k carbon fibre could also be substituted therefore. In the embodiment shown in figures, the load-facing stiffening layer 22 comprises two plies 22a and 22b of woven 12k carbon fibre which are cross-plied such that the fiber alignment direction of one layer is rotated at an angle with respect to the fiber alignment direction of another layer. The cross-plying resulting in the alignment direction of one layer that is rotated at an angle with respect to the alignment direction of an adjacent layer. In one aspect, the angle is greater than 0 degrees and less than or equal to 90 degrees. In a further aspect, the load-facing stiffening layer 22 comprises a plurality of carbon fibre layers aligned in such a manner that a second layer is rotated at 90 degrees with respect to a first layer and a third layer applied over the second layer but this third layer is rotated at 45 degrees with respect to the first layer. Additional plies of 12k carbon fibre layered in an angled alignment may also be used.

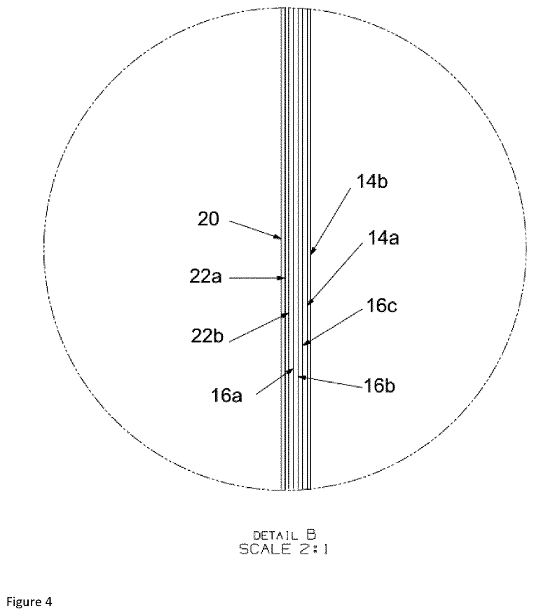

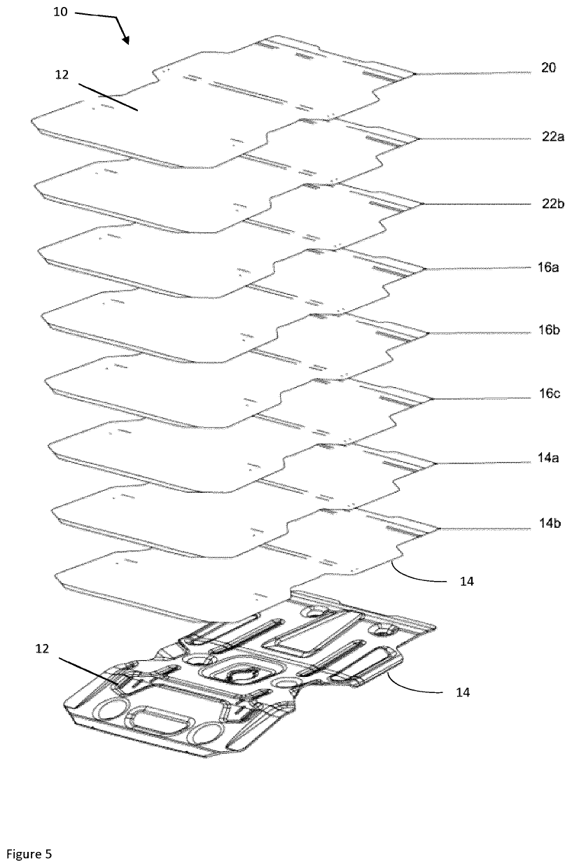

The core 16 is disposed adjacent to impact-facing surface 12. In aspects, the core 16 is bonded to the impact-facing surface 12. The core 16 comprises a fibre material configured to increase the moment of inertia and for receiving high deformation where the fibre material absorbs and distributes forces of the load across a wider area. In some aspects, the fibre material is glass which has higher impact resistance than carbon fibre and is relatively less stiff. As shown in FIGS. 4 and 5, in one aspect, the core 16 comprises three layers 16a, 16b, and 16c of glass fibre material that are cross-plied such that the fiber alignment direction of one layer is rotated at an angle with respect to the fiber alignment direction of another layer. The cross-plying resulting in the alignment direction of one layer that is rotated at an angle with respect to the alignment direction of an adjacent layer. In another aspect, the three layers of glass fibres are aligned in such a manner that a second layer is rotated at 90 degrees with respect to a first layer and a third layer applied over the second layer but this third layer is rotated at 45 degrees with respect to the first layer. Although the core containing three layers of glass fibres are suitable to increase the moment of inertia and to absorb the load forces and disperse the received energy, there can be fewer or greater than three glass fibre layers. In one embodiment, the core comprises at least one layer of glass fibre material and in other embodiments the core comprises at least ten layers of glass fibre material.

As shown in FIG. 5, the body-facing surface 14 is formed using high strength materials and wherein such material is adjacent to the core 16 on one side. In aspects, the body-facing surface 14 is bonded to the core 16. In the embodiment shown in FIGS. 4 and 5, the body-facing surface comprises body-facing stabilizing layers 14a and 14b of one or more 12 k carbon fibre layers. In some aspects, there may be two plies 14a and 14b of carbon fibre which are cross-plied. The cross-plying resulting in the alignment direction of one layer that is rotated at an angle with respect to the alignment direction of an adjacent layer. In one aspect, the angle is greater than 0 degrees and less than or equal to 90 degrees. In a further aspect, the body-facing stabilizing layer 14 comprise a plurality of carbon fibre layers aligned in such a manner that a second layer is rotated at 90 degrees with respect to a first layer and a third layer applied over the second layer but this third layer is rotated at 45 degrees with respect to the first layer. In aspects, while 12 k carbon fibre is used in the present embodiment, other known types such as 3k, 6k, and 15k carbon fibre could also be substituted therefore. Without being limited to any particular theory, the body-facing stabilizing layer 14 functions to stabilize the composite matrix and prevent delamination of the composite structure 10.

The composite structure 10 including the impact-facing surface 12, the core 16, and the body-facing surface 14, can be bonded together as a matrix using a bond or adhesive. In aspects the bond or adhesive is a resin. In further aspects, the resin is an epoxy resin, and the process used to form the hybrid structure is resin transfer molding. In further aspects, the resin is one of polypropylene, polyamide and polyphenylene sulfide.

As shown in FIGS. 1, 2, 5, and 6, the composite structure 10 defines a plurality of mounting holes 30, each mounting hole configured to enable a mounting bolt to pass therethrough for attachment of the structure to the underbody of a vehicle 2. A reinforcement ring 40 within the perimeter of each mounting hole is provided to distribute torque of the mounting bolting.

Although vehicle 2 is shown as a truck, it should be appreciated that vehicle 2 it not limited and may be any vehicle such as for example, a ground, sea, or air vehicles that contain impact-sensitive components needing protection from external impacts by use the composite structure 10 of the present disclosure.

### EXAMPLE

Several materials were manufactured in the form of flat panels combining different fibers, resins, and manufacturing processes. Flat panels consisting of an epoxy resin bonded composite laminate of the present invention comprising a layer of spread carbon fibre chop, 12 k carbon fibre as a stiffening layer, glass fibre layer 782 gsm core, and a 12 k carbon fibre as a stabilizing layer were compared to metal, aluminum, and monolithic laminates. The composite laminates, monolithic laminates and metal structures were tested under the impact, static and dynamic loads. While, monolithic laminates of carbon fibers performed well under static and dynamic loads, these presented cracks or scratches under impact. Monolithic laminates of glass fibres were not stiff enough to hold the static load.

The lightweight composite laminates of the present invention demonstrated superior stiffness, superior impact resistance, and resistance to shear deformation as compared the monolithic laminates and have similar mechanical performance of steel and aluminum and having corrosion and fire resistance while being lightweight and sufficiently stiff to bear weight of the vehicle.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a sub combination of features which may not be explicitly described above. In addition, features from one or more of the above-described embodiments may be selected and combined to create alternate embodiments comprised of a combination of features which may not be explicitly described above. Features suitable for such combinations and sub combinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

1. A composite load protection structure for protecting impact-sensitive components of a vehicle from a strike by a load, the structure comprising:
a core fabric layer;
a stiffening layer that is configured to resist deformation upon the strike by a load on one side of the core fabric layer and a stabilizing layer on the other side of the core fabric layer; and
an adhesive to bond the stiffening layer and the stabilizing layer on the opposed sides of the core fibre layer, wherein the core fabric layer has a lower stiffness and increased ductility than the stiffening layer and the stabilizing layer.

2. The structure of claim 1 wherein the stiffening layer resists deformation when the strike by a load is below a deforming threshold.

3. The structure of claim 2 wherein the core fabric layer is configured to increase moment of inertia and receive the strike by a load and deform when the strike by a load is above the deforming threshold.

4. The structure of claim 3 wherein the core fabric layer comprises one or more plies of glass fibres.

5. The structure of claim 4 wherein two or more plies of glass fibre are cross-plied such that fiber alignment of one layer is rotated about an angle with respect to the fiber alignment of an adjacent layer.

6. The structure of claim 4 wherein three plies of glass fibres are cross-plied such that a first ply and a second ply are rotated about a 90 degree angle and a third ply is rotated about a 45 degree angle with respect to the first ply.

7. The structure of claim 1 wherein the stiffening layer and the stabilizing layer comprise a plurality of plies of carbon fibres.

8. The structure of claim 7 wherein the plurality of plies carbon fibre are cross-plied such that the fiber alignment direction of one layer is rotated at an angle with respect to the fiber alignment direction of another layer.

9. The structure of claim 8 wherein the angle is greater than 0 and less than or equal to 90 degrees.

10. The structure of claim 1 wherein the stiffening layer and the stabilizing layer comprise a plurality of plies of carbon fibres aligned in such a manner that a second layer adjacent to a first layer is rotated at about 90 degrees with respect to the first layer and a third layer adjacent to the second layer is rotated at about 45 degrees with respect to the first layer.

11. The structure of claim 1 wherein the stiffening layer comprises an outward-facing spread carbon fibre chop layer configured to receive the strike and a load-facing stiffening carbon fibre layer adjacent to the core fabric layer.

12. The structure of claim 11 wherein the load-facing stiffening carbon fibre layer is configured to provide significant stiffening properties.

13. The structure of claim 11 wherein the load-facing stiffening layer comprises 3 k, 6 k, 12 k, or 15 k carbon fibre.

14. The structure of claim 1 wherein the stabilizing layer comprises 3 k, 6 k, 12 k, or 15 k carbon fibre.

15. The structure of claim 1 wherein the adhesive is a resin.

16. The structure of claim 15 wherein the resin is polypropylene, polyamide, polyphenylene sulfide or an epoxy resin.

17. The structure of claim 1 for use as skid plate, a bumper, or a battery housing.

18. The structure of claim 1 wherein the core fabric layer comprises a 782 gsm glass fibre; the stiffening layer comprises a carbon fibre chop layer and a 12 k carbon fibre stiffening layer adjacent to the core fabric layer; the stabilizing layer comprises a 12 k carbon fibre stiffening layer; and the adhesive is an epoxy resin.

19. A vehicle skid plate for protecting impact-sensitive components of a vehicle from a strike by a load, the structure comprising:
a glass fibre layer;
a stiffening layer that is configured to resist deformation upon the strike by a load on one side of the glass fibre layer and a stabilizing layer on the other side of the glass fibre layer; and
an adhesive to bond the impact-facing layer and the stabilizing layer on the opposed sides of the glass fibre layer, wherein the glass fibre layer has a lower stiffness and increased ductility than the stiffening layer and the stabilizing layer, wherein the stiffening layer resists deformation when the strike by a load is below a deforming threshold, and wherein the glass fibre layer is configured to increase moment of inertia and receive the strike by a load and deform when the strike by a load is above the deforming threshold of the stiffening layer.

20. The vehicle skid plate of claim 19 wherein the stiffening layer and the stabilizing layer comprise a plurality of plies of carbon fibers.
